(19) United States
(12) Patent Application Publication
(10) Pub. No.: US 2011/0125682 A1
(43) Pub. Date: May 26, 2011

(54) LEARNING DEVICE

(76) Inventor: Do Young Kim, Seoul (KR)

(21) Appl. No.: 13/055,895

(22) PCT Filed: Jul. 3, 2009
(86) PCT No.: PCT/KR2009/003644

§ 371 Date: Jan. 25, 2011

(30) Foreign Application Priority Data
Jul. 29, 2008 (KR) 10-2008-0074058
Jun. 23, 2009 (KR) 10-2009-0056008

(51) Int. Cl. G06F 15/18

(52) U.S. Cl. 706/12

(57) ABSTRACT

Provided is a learning device that represents the learning contents of a learning edition in visual and audio elements such as voice, melody, and image. The learning contents are pointed out by an indicator according to the principle of signal transmission and reception for recognizing the position of the indicator.

### TECHNICAL FIELD

The present invention relates to a learning device that represents the learning contents of a learning board indicated by an indicator, using audio and visual elements, such as voice, melody, and image, in accordance with a signal communication principle for recognizing the position of the indicator.

### BACKGROUND ART

In general, learning boards (or picture boards) that are used for learning characters, numbers, and objects are made of paper with characters, numbers, or pictures printed in various types and attached to a wall or opened on a ground for use. However, they depend on only the visual part, such that users easily feel repugnance and the learning effect is not large.

Further, the type of outputting corresponding contents when a user presses learning contents on the learning board, using voice or melody, is formed by applying conductive materials on the back of printing paper and other lower layers such that electricity flows and voice and melody are outputted when a user presses it.

Therefore, since conductive materials are applied on a learning board in several layers and the learning board is composed of several flexible boards that are bonded, such that it may be easily crumpled or the bonding portions may be separated, such that it may not function as a learning board.

### DISCLOSURE

### Technical Problem

The present invention has been made in an effort to solve the problems described above and it is an object of the present invention to provide a learning device that improves a learning effect by providing learning data corresponding to learning contents of a learning board, using voice and image etc., in accordance with a signal communication principle for recognizing the position of an indicator.

Further, it is another object of the present invention to provide a learning device that includes an indicator having a contact recognizer provided with an on/off switch, in which when the switch of the contact recognizer is turned on, a first transceiver and a second transceiver spaced at a distance from the main body of the learning device transmit ultrasonic signals to the indicator in response to an infrared signals generated from the indicator, such that the position indicated by the indicator is effectively measured while power of the learning device is saved, thereby outputting learning data corresponding to the position.

Further, it is another object of the present invention to provide a learning device that can measure the position of an indicator and effectively output corresponding learning data, without making a first transceiver and a second transceiver spaced at a distance from the main body of the learning device transmit again specific signals to the indicator, in response to infrared and ultrasonic signals generated from the indicator when a switch of a contact recognizer is turned on.

Further, it is another object of the present invention to provide a learning device that can use various learning methods and improve the learning effect by allowing for selecting learning methods through selection buttons that makes it possible to select learning methods for the learning contents of a learning board.

Further, it is another object of the present invention to provide a learning board that overcomes a limit in learning contents of the related art and uses various contents as learning data by scanning and imaging the learning contents printed on a learning board and creating the imaged learning contents of the learning board as learning data.

### Technical Solution

In order to achieve the objects of the present invention, a learning device according to an embodiment of the present invention includes: a main body disposed on a learning board representing learning contents; and an indicator indicating a predetermined position on the learning board under the main body, in which the main body includes: a transceiver that transmits a signal for recognizing the position to the indicator and receives a signal reflected from the indicator; a processor that calculates the position on the learning board indicated by the indicator by communicating a signal with the indicator; and an output unit that outputs learning data corresponding to the position calculated by the processor.

The transceiver is composed of a first transceiver and a second transceiver which are installed at predetermined distances from the main body.

The processor calculates the position on the learning board indicated by the indicator, using an angle α measured on the basis of a first signal that is transmitted from the first transceiver to the indicator and then reflected from the indicator to the second transceiver, an angle β measured on the basis of a second signal that is transmitted from the second transceiver to the indicator and then reflected from the indicator to the first transceiver, and the distance between the first transceiver and the second transceiver.

The processor calculates the position on the learning board indicated by the indicator, using a distance between the first transceiver and the indicator which is measured on the basis of a first signal that is transmitted from the first transceiver to the indicator and then reflected from the indicator to the first transceiver, a distance between the second transceiver and the indicator which is measured on the basis of a second signal that is transmitted from the second transceiver to the indicator and then reflected from the indicator to the second transceiver, and the distance between the first transceiver and the second transceiver.

The signal received to the indicator is any one of an RF signal and an ultrasonic signal.

The output unit includes at least one of a voice output unit that outputs the learning data in voice and a video output unit that outputs the learning data in video.

The indicator includes a contact recognizer having an on/off switch disposed at an end in a spring type, and the transceiver transmits the signal to the indicator when the switch of the contact recognizer is turned on.

The main body further includes: a learning data storage that stores learning contents of the learning board in learning data type made in data; and a schedule storage that stores at least one of time information on a learning time for the learning contents of the learning board and information on a learned time and learning results.

The main body further includes a function button unit having at least one of a button for selecting learning method of the learning contents in the learning board, a set button for setting the learning time, a sound record button for recording the voice of a user, and a video record button for recording video.

The schedule storage outputs recorded voice or recorded video on a screen at the learning time.

The main body further includes an interface that communicates data with an external device, and the interface allows data about the learning results to be analyzed by the external device by transmitting information on the learning results to the external device.

The main body further includes a scan unit that scans and images the learning contents of the learning board and creates the imaged learning contents of the learning board in the learning data.

A learning device according to another embodiment of the present invention includes: a main body disposed on a learning board representing learning contents; and an indicator indicates a predetermined position on the learning board under the main body and transmitting wireless signals to the main body, in which the main body includes: a receiving sensor that receives a wireless signal transmitted from the indicator; a processor that calculates the position indicated by the indicator, using the wireless signal received to the receiving sensor; and an output unit that outputs learning data corresponding to the position calculated by the processor.

The wireless signals are an infrared signal and an ultrasonic signal, and the receiving sensor is composed of an infrared sensor that receives the infrared signal, and a first ultrasonic sensor and a second ultrasonic sensor which are installed at predetermined distances from the main body and receive the ultrasonic signal.

The infrared sensor is turned on when receiving an infrared signal from the indicator such that the first ultrasonic sensor and the second ultrasonic sensor receive ultrasonic signals transmitted from the indicator.

The processor calculates the position on the learning board indicated by the indicator, using a distance between the indicator and the first ultrasonic sensor which is measured on the basis of a first ultrasonic signal transmitted from the indicator to the first ultrasonic sensor, a distance between the indicator and the second ultrasonic sensor which is measured on the basis of a second ultrasonic signal transmitted from the indicator to the second ultrasonic sensor, and the distance between the first ultrasonic sensor and the second ultrasonic sensor.

The indicator includes a contact recognizer having an on/off switch disposed at an end in a spring type and transmits the infrared signal and the ultrasonic signal to the receiving sensor, when the switch of the contact recognizer is turned on.

### Advantageous Effects

According to a learning device of the present invention, it is possible to expect the following effects.

First, the present invention has the advantage of improving the learning effect by providing learning data corresponding to the learning contents in a learning board in voice and video, in accordance with signal communication principle for recognizing the position of an indicator.

Second, it has the advantage of including an indicator having a contact recognizer provided with an on/off switch, in which when the switch of the contact recognizer is turned on, a first transceiver and a second transceiver spaced at a distance from the main body of the learning device transmit ultrasonic signals to the indicator in response to an infrared signals generated from the indicator, such that the position indicated by the indicator is effectively measured while power of the learning device is saved, thereby outputting learning data corresponding to the position.

Third, it has the advantage of being able to measure the position of an indicator and effectively output corresponding learning data, without making a first transceiver and a second transceiver spaced at a distance from the main body of the learning device transmit again specific signals to the indicator, in response to infrared and ultrasonic signals generated from the indicator when a switch of a contact recognizer is turned on.

Fourth, it has the advantage of being able to use various learning methods and improve the learning effect by allowing for selecting learning methods through selection buttons that makes it possible to select learning methods for the learning contents of a learning board.

Fifth, it has the advantage of being able to overcome a limit in learning contents of the related art and use various contents as learning data by scanning and imaging the learning contents printed on a learning board and creating the imaged learning contents of the learning board as learning data.

Sixth, it has the advantage of being able to induce infants to listen to parents' voice and friendly approach the learning device by outputting user's voice at a predetermined time, and providing more effective learning and management by storing a learned time and learning results to be checked by voice and video.

Seventh, it has the advantage of being able to provide convenience in determining the learning effect and the learning direction by allowing the learning results to be transmitted to an external device such that detailed learning results are analyzed by the external device.

### DESCRIPTION OF DRAWINGS

FIG. 1 is a diagram showing a learning device according to an embodiment of the present invention.

FIG. 2 is a block diagram of the learning device shown in FIG. 1.

FIG. 3 is a conceptual diagram illustrating measuring the position of an indicator, using triangulation.

FIG. 4 is a diagram showing a learning board-making program for making a learning board.

FIG. 5 is a diagram showing a learning device according to another embodiment of the present invention.

FIG. 6 is a block diagram of the learning board shown in FIG. 5.

FIG. 7 is a conceptual diagram illustrating the principle of a learning device according to another embodiment of the present invention.

### BEST MODE

The present invention is described hereafter in detail with reference to the accompanying drawings showing preferred embodiments of the present invention.

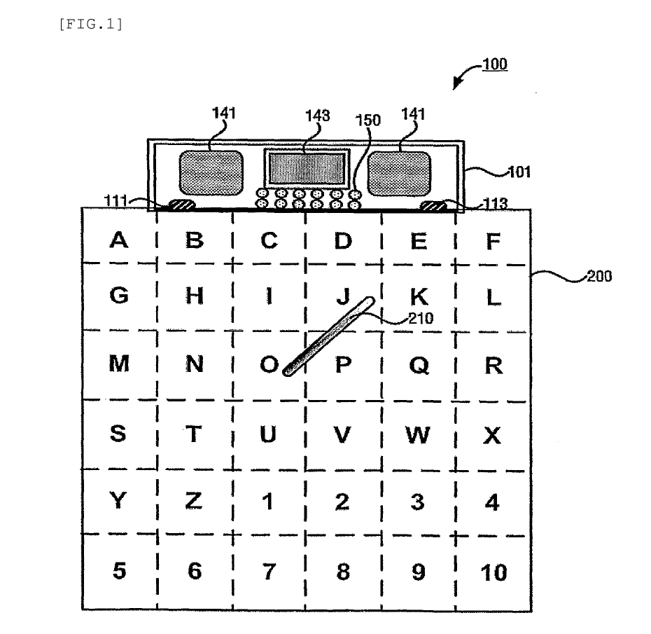

FIG. 1 is a diagram showing a learning device according to an embodiment of the present invention.

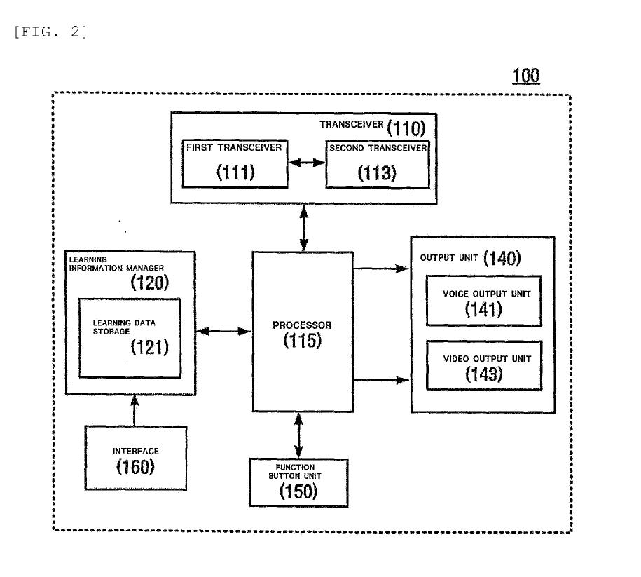

As shown in FIG. 1, a learning device 100 includes a main body 101 on a learning board 200 with learning contents and an indicator 210 for indicating predetermined positions on the learning board 200 under the main body 101. Further, the main body 101 includes a transceiver 110 that transmits a position signal for recognizing the position to the indicator 210 and receives a signal reflected from the indicator 210, a processor 115 (see FIG. 2) that calculates the position indicated by the indicator 210 on the learning board 200 by communicating a signal, and an output unit 140 that outputs learning data corresponding to the position calculated by the processor 115.

Further, the indicator 210 includes a contact recognizer (not shown) having an on/off switch formed in a spring shape, at the end, and the transceiver 110 transmits a signal for recognizing the position on the learning board 200 indicated by the indicator 210 to the indicator 210, when the switch of the contact recognizer is turned on.

The learning device 100 may be manufactured a thin wall-mounted type to be mounted on a wall, such as a wall-mounted TV or a stand type to be installed at predetermined places and the main body 101 of the learning device 100 may include a fixing means (not shown) at a side of the main body 101 to be hung on or attached to a wall.

Further, the learning board 200 has only to be a type with learning contents on various materials, such as towel, a map of the world, or a wallpaper, and the learning device may be put on a market, with data for learning contents of a plurality of learning boards 200 stored in the main body 101, by manufacturing a plurality of learning board 200 in manufacturing the product.

Further, the main body 101 and the learning board 200 may be separately manufactured and sold, in which it is possible to be provided with data relating to the learning contents of the learning board 200 in the main body 101 from the service provider or download it from the website of the product.

Meanwhile, the learning device 100 can calculate the coordinates of the position of the indicator 210, using the communication time, distance, and angle etc. of a signal and output learning data corresponding to the coordinate in voice through an voice output unit 141 or display an image through an image output unit 143, by transmitting a signal to the indicator 210 on the learning board 200 and receiving a reflected signal, using the first transceiver 111 and the second transceiver 113 which are spaced at predetermined distances from the main body 101.

In this process, as described above, when the switch of the contact recognizer in the indicator 210 is turned on, the indicator 210 transmits an infrared signal to the transceiver 110 and the transceiver 110 receiving the infrared signal for recognizing the position of the indicator 210 to the indicator 210.

The use of the learning device 100 using this principle is described with reference to an example. As shown in FIG. 1, the main body 101 is disposed on the learning board 200 printed with numbers of English characters, such as “A, B, C, D, E, F, G, H, I, J, K, L, M . . . ”.

Thereafter, when a user selects “press” from learning methods, such as “press”, “repeat”, and “find” in a function button unit 150 and indicates “F” on the learning board 200 with the indicator 210, “F” is displayed on the screen of the image output unit 143 and voice “ef” is outputted through the voice output unit 141.

Hereinafter, the operation and principle of the components in the learning device 100 illustrated in detail in FIG. 2 are described in detail by making the functions of the learning device 100 in blocks.

FIG. 2 is a block diagram of the learning device shown in FIG. 1.

As shown in FIG. 2, the learning device 100 includes the transceiver 110, the processor 115, a learning information manager 120, the output unit 140, the function button unit 150, and an interface 160.

The transceiver 110 is composed of the first transceiver 111 and the second transceiver 113, in which it is preferable that the first transceiver 111 and the second transceiver 113 are spaced at predetermined distance from the main body 101. That is, the first transceiver 111 and the second transceiver 113 are disposed at both sides of the main body 101 to calculate the position of the indicator 210 by communicating signals for the indicator 210 on the learning board 200.

Further, the signals transmitted from the first transceiver 111 and the second transceiver 113 may be RF (Radio Frequency) signals, infrared signals, or ultrasonic signals, and the first transceiver 111 and the second transceiver 113 transmit signals for recognizing the position on the learning board 200 indicated by the indicator 210 to the indicator 210, when the switch of the contact recognizer of the indicator 210 is turned on.

Therefore, when the switch of the contact recognizer of the indicator 210 is turned off, the first transceiver 111 and the second transceiver 113 do not operate and the power of the learning device 100 may be maintained in a saving mode by control of the processor 115.

The processor 115 controls the functions of the components in the learning device 100 and calculates the position indicated by the indicator 210 on the learning board 200 by communicating signals.

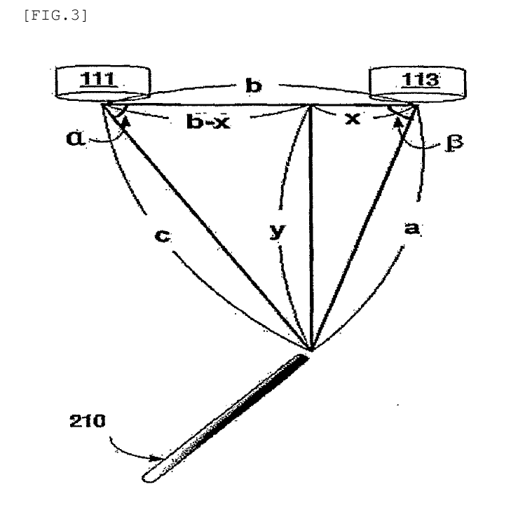

FIG. 3 is a conceptual diagram illustrating measuring the position of an indicator, using triangulation.

Continuing describing, the position of the indicator 210 can be calculated by the triangulation shown in FIG. 3 and the processor 115 can calculates the position of the indicator 210, using to following two position recognition methods.

According to a first position recognition method, the process 115 can calculates an angle α measured in response to a first signal reflected from the indicator 210 and transmitted to the second transceiver 113 after being transmitted from the first transceiver 111 to the indicator 210, an angle β measured in response to a second signal reflected from the indicator 210 and transmitted to the first transceiver 111 after being transmitted from the second transceiver 113 to the indicator 210, and the position on the learning board 200 indicated by the indicator 210, using the distance between the first transceiver 111 and the second transceiver 113.

According to a second position recognition method, the processor 115 can calculate the distance between the first transceiver 111 and the indicator 210 which is measured in response to a first signal reflected from the indicator 210 and transmitted to the first transceiver 111 after being transmitted from the first transceiver 111 to the indicator 210, the distance between the second transceiver 113 and the indicator 210 in response to a second signal reflected from the indicator 210 and transmitted to the second transceiver 113 after being transmitted from the second transceiver 113 to the indicator 210, and the position on the learning board 200 indicated by the indicator 210, using the distance between the first transceiver 111 and the second transceiver 113.

As described above, the processor 115 measures the position of the indicator 210, that is, the coordinates on the learning board 200, extracts learning data corresponding to the coordinate from a learning data storage 121, and outputs them with voice, an image, or melody etc. through the output unit 140.

Meanwhile, the process of calculating the position of the indicator 210 using the triangulation is described in more detail to help understand. In the second position recognition method, the first transceiver 111 and the second transceiver 113 each transmit a signal for sensing the indicator 210 at a predetermined position on the learning board 200, in which the distances from the indicator 210 can be calculated from the speed (e.g. V(m/s)=343 m for an ultrasonic wave) and time of the signals reflecting and returning to the transceivers.

When an ultrasonic wave is used, since the speed of the ultrasonic wave is influenced by temperature, the processor 115 can calculates the distances between the transceivers 111 and 113 and the indicator 210 in consideration of the influence (a formula for temperature compensation may be V(m/s)=331.5+0.60714 T).

As described above, after the distances between the first transceiver 111 and the indicator 210 and between the second transceiver 113 and the indicator 210 are calculated, the distance between the first transceiver 111 and the second transceiver 113 has been fixed and can be measured, such that the lengths of all of three sides of a triangle constructed by the indicator 210, the first transceiver 111, and the second transceiver 113 can be calculated and the desired position (x,y) of the indicator 210 can be calculated from Heron's Formula

$$( y = \frac{z \sqrt{z ( z - a ) ( z - b ) ( z - c )}}{b} , z = \frac{( a + b + c )}{c} )$$

and Pythagorean theorem (x=\sqrt{a²−y²}), on the basis of the lengths. Therefore, since the position of the indicator 210, that is, the coordinates of the learning board 200 is calculated from the above, learning data corresponding to the coordinates can be detected.

Next, the learning information manager 120 includes the learning data storage 121 and saves, deletes, adds, and changes the data.

In this process, the learning data storage 121 stores learning data including learning contents of the learning board 200 in data, in which the coordinates of the learning board 200 can be stored together with the data. That is, the learning data storage 121 stores various types of learning data, such as Korean consonants and. vowels, English alphabets, Korean words, English words, pictures, Korean sentences, English sentences, and Chinese characters.

Therefore, since the learning contents of the learning board 200 are arranged at predetermined coordinates (or divided sections) on the learning board 200 and the learning data and coordinates corresponding to the learning contents at the coordinates are stored in the Learning data storage 121, the learning data for the learning contents at the positions selected by a user can be detected and displayed on the screen.

The learning data may be set in advance and store accordance with the learning contents of the learning board 200, inputted by selection of a user, or used by storing learning data provided on the internet in an USB stick or an SD card and connecting the USB stick or the SD card to the learning device 100.

Further, the learning device 100 can receive learning data, using wireless local communication (e.g. Bluetooth and Zigbee etc.) and use it, or desired learning data can be received from a PC and used by directly connecting the PC with the learning device 100 using an USB cable.

Further, a user may directly make a desired shape of learning board 200 and use the learning data. For this purpose, a learning board 200-making program is provided and the program learning board 200-making program may be provided in a storage medium, such as a CD, to a user or downloaded from a webpage and installed in a personal computer by a user. Further, it is preferable that the learning board 200-making program is made such that it is possible to find the position of each section from the program by inputting only minimum information, that is, the transverse and longitudinal lengths of the learning board 200, the number of divided sections, and learning data allocated to the sections, in order for a user to simply use it.

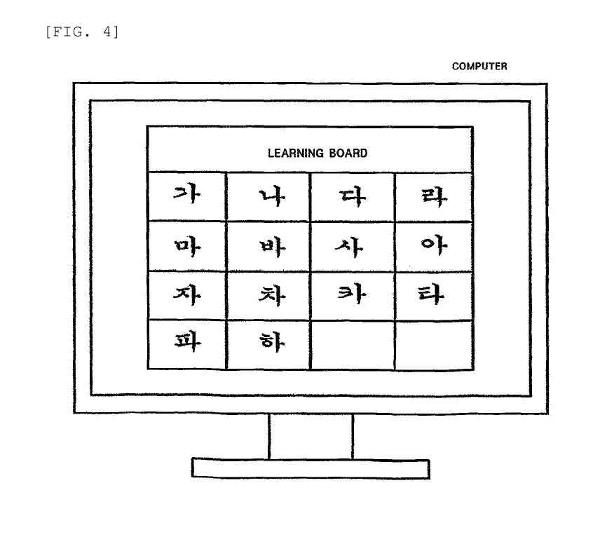

FIG. 4 is a diagram showing a learning board-making program for making a learning board.

Continuing describing, as shown in FIG. 4, a type in which a user simply inputs desired learning data in the sections divided transversely and longitudinally, using a keyboard may be provided. In this type, the user can call and use a basically set type, such as 2×2, 4×4, and 8×8, and the set sections may be combined or divided by selection of the user. Further, it is possible to input data, using various characters, such as Korean, Chinese, and English, and to set and input the colors and fonts of the characters in various ways.

Further, it is possible to set in advance various animal pictures, fruit pictures, object pictures etc. and corresponding voice data in the learning board 200-making program such that a user can call desired pictures from them and put the pictures in corresponding sections.

Further, when the user finishes inputting data and selects a save function, the learning board 200-making program converts the values inputted by the user into the type of learning data and creates and stores voice data corresponding to the coordinates and learning data of the learning board 200. In this process, it is possible to create the voice data, using TTS (Text To Speech) and well-known TTS solution may be used.

When the user finishes making the learning board 200 in the type described above, the user can output the learning board 200 using a printer and connect the learning board 200 to the main body 101 for use.

Meanwhile, other than the above, the user can insert background music of the corresponding learning board 200, using the learning board 200-making program and the background music can be stored in the learning data storage 121 together with the identification number of the learning board 200 and played while learning is performed through the corresponding learning board 200. In this case, a play button may be included in the function button unit 150, which is described below, and the user presses the play button to play the background music.

Further, user can make the basic information of an existing learning board (e.g. the transverse and longitudinal lengths of the learning board, the number of divided sections, and learning data allocated in the sections) in learning data type without making the learning board 200 directly and apply it to the present invention

Meanwhile, returning to FIG. 2, the output unit 140 is provided to output corresponding learning data in an image and audio to the outside in accordance with the learning contents selected from the learning board 200 by the user, and is at least one of the voice output unit 141 and the image output unit 143. In this configuration, the voice output unit 141 may be implemented in a speaker type and the image output unit 143 may be implemented by a display, such as an LED or an LCD.

Further, the function button unit 150 basically includes buttons that makes it possible to select the learning methods, such as “press”, “repeat”, and “find” and buttons that represent Korean consonant and vowels, English alphabets, Korean words, English words, pictures, Korean sentences, English sentences, and Chinese characters such that it is possible to freely select one of them to learn.

Further, the function button unit 150 may include various buttons, such as a play button for playing background music while learning is performed, a setting button for setting a learning time, a sound record button for recording voice, a video record button for recording video, a power button for turning on/off the power, and a scan button for scanning.

In this configuration, the function button unit 150 makes it possible to record and store the user's voice and various videos by means of the sound record button and the video record button, such that the user's voice (or various sound source) and video can be outputted through a schedule storage 125, which is described below, by control of the processor 115 when it is the learning time.

Further, the interface 160 includes a predetermined shape of connection port such that data can be communicated between wire or wireless external devices and the learning device 100. For example, the interface 160 may include an USB connection port such that a user can freely download various types of learning data from the internet, store the learning data in a storage medium, such as an USB stick, and stores it in the learning data storage 121 by connecting the storage medium to the learning device 100.

Further, the learned time (date and month etc.) and the learning result (point etc.) are stored in the learning device 100 and transmitted to a PC (or an external device) through the interface 160, such that it is possible to analyze data for the user's learning result, and the user can check the learning result in voice or video through the voice output unit 141 and the video output unit 143. In this configuration, the external device includes information of accumulated learning results of the user, such that estimation and level measurement are performed for the learning results of the user.

However, when the interface 160 is provided with a port for connection with a microphone, the user can store the learning contents and recorded voice in the learning data storage 121 by selecting the learning contents in the learning board 200 and inputting voice for the learning contents through the microphone.

In this process, the user can record a variety of effect sounds and voice corresponding to the learning contents by selecting the learning contents and recording voice, with the sound record button of the function button unit 150 pressed, and returning the sound record button after finishing sound-recording. Thereafter, the user can listen to the recorded sound corresponding to the learning contents, such that it is possible to learn in interesting and various methods.

Further, when the interface 160 may be provided with a port for inserting an earphone jack, the user can listen to the learning contents of the learning board 200, such that it is possible to learn with higher concentration.

Meanwhile, the learning device 100 may be provided with a batter inserting portion (not shown) at the bottom such that power is supplied by a rechargeable battery or external power can be directly supplied by connecting an external power jack, other than the battery.

When external power can be directly supplied by connecting an external power jack, the user can control power supply for the learning device 100 by turning on/off the power button of the function button unit 150.

Further, the processor 115 described above can perform a power save control operation for automatically cutting the power, when the components do not operate for a predetermined time, with the power of the learning device 100 off, in which a power save module (not shown) for the power save function may be further provided.

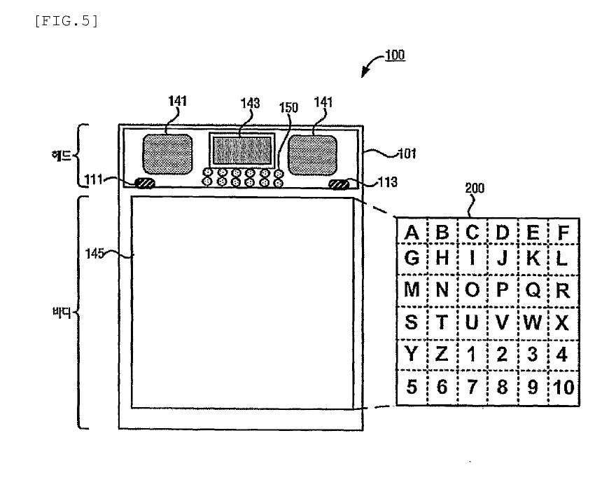

FIG. 5 is a diagram showing a learning device according to another embodiment of the present invention.

As shown in FIG. 5, a main body 101 of the learning device 100 may be composed of a head and a body and the body may be additionally provided with a panel 145 supporting a learning board 200.

In this configuration, the panel 145 may be a simple support plate for supporting the learning board 200 or a functional panel that displays an image or scans.

When the panel 145 is a display, the learning board 200 is displayed on the panel 145 by selecting an English and number learning board 200 in the buttons of the function button unit 150 by the user, without a specific printed learning board 200. Further, when a “lion” is selected from the learning board 200 including various animal pictures and characters relating to animals, the shape of a “lion” can be displayed largely in the entire screen of the panel 145.

Further, when the panel 145 is provided with a scan function, it is possible to place a learning board 200 printed with, for example, [symbol] [symbol] [symbol] and [symbol] on the panel 145 and scan it by pressing the scan button of the function button unit 150, thereby storing and using the it as learning data. In this case, sound or voice corresponding to the characters may be stored together with the characters by a function of reading the characters (English, Korean, Chinese characters, symbol and so on).

The examples of the learning methods are provided just to help understand the present invention and the learning methods may be implemented in various ways in accordance with user's selection.

That is, when a learning board 200 with pictures printed is used, two indicators 210 for a parent and an infant may be provided such that the parent and the infant can learn together while playing games, for example, when the parent presses “animal”, the infant presses “lion”.

By implementing a configuration that allows parents and infants to learn together, it is possible to not only more improve the learning effect by increasing the infants' interest in learning, but achieve an effect of rapport between the parents and infants.

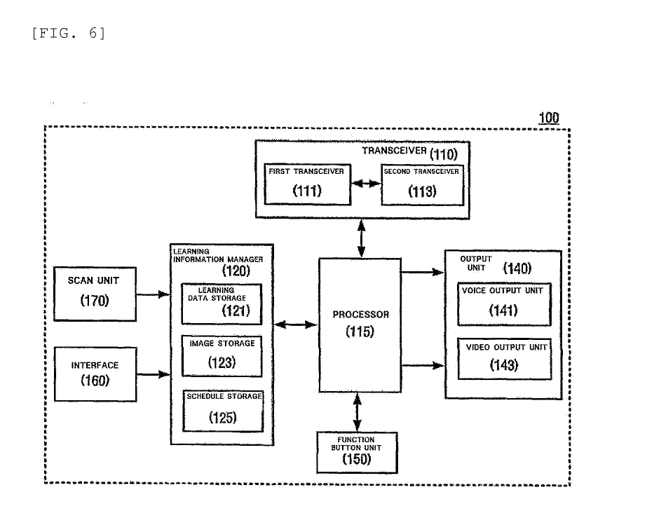

FIG. 6 is a block diagram of the learning device shown in FIG. 5.

Hereinafter, repeated description for the components of FIG. 2 is not provided and the operational principle according to another embodiment that can be implemented by the learning device 100 is described in detail.

As shown in FIG. 6, the learning device 100 according to another embodiment further includes a scan unit 170, an image storage 123, and a schedule storage 125.

The scan unit 170 scans and images learning contents of the learning board 200, classifies the imaged learning contents of the learning board 200 in accordance with predetermined sections (e.g. 2×2, 4×4, or 8×8) in data, and creates them in learning data.

For example, the scan unit 170 may be useful, when the learning device 100 is equipped with the panel 145 and the panel 145 has a scan function. For this purpose, a user presses the scan button in the function button unit 150 to scan the learning contents of the learning board 200 on the panel 145, and indicates a predetermined learning content of the learning board 200 after the scanned contents are formed in the learning data, thereby the corresponding learning data is outputted in video or voice.

In this configuration, it is possible to reconstruct the scanned images, using the learning board 200-making program, such that it is possible to process a variety of effect sounds, voice, and data.

The image storage 123 can store images corresponding to the contents of the learning data and the images may be avatars, cartoons, or photographs etc. The image storage 123 may be useful, when the learning device 100 is equipped with the panel 145 and the panel 145 has a display function. For example, avatar images may be outputted with the learning data on the screen of the panel 145, and it is possible to improve infants' interest in learning, using animation characters, such as cartoons.

That is, when a learning content that an infant will lean is selected by the function button unit 150, the panel 145 outputs learning data in the type of learning board 200 on the screen of the panel 145. In this case, the user can make the learning content be displayed on the panel 145, without printing out the learning board 200.

Further, when the user selects a predetermined content from the learning contents displayed on the panel 145, the user can see the selected learning content by means of the coordinates of the corresponding learning content, and it is possible to improve visual interest by representing the learning data in voice or video through the output unit 140 or by displaying the extracted learning data on the panel 145 itself in a large size.

Further, it is possible to induce infants to participate in learning with more interest by making avatars stored in the image storage 123 appear on the panel 145 and say or act the learning data according to the learning content selected by user.

For example, when a “lion” is selected from the learning board 200, an avatar having the shape of “lion” may appear on the panel 145 and take an action with the sound of the lion.

In this configuration, it is possible to store a corresponding avatar with the learning data (“lion”), using the learning board 200-making program described above, and, when a server computer (or a personal computer) and the learning device 100 are connected, the processor 115 in the learning device 100 transmits the learning data (“lion”) or the coordinates for the learning content selected by the user to the server computer, such that the server computer can make an avatar corresponding to the learning data appear on the panel 145 and control the avatar to say or act the learning data.

Therefore, the image storage 123 may be included in the server computer and various dynamic or static images, such as characters and photographs, other than the avatars, may be matched with the learning data (or coordinates) and displayed on the panel 145 by the server computer. Further, it is obvious that some of the components shown in FIG. 2 or FIG. 6 are implemented in the server computer and interactive operations for output of the learning data corresponding to received coordinates can be performed between the server computer and the learning device 100, depending on configurations.

Meanwhile, the schedule storage 125 stores scheduling information on the learning data. That is, the schedule storage 125 can arrange and store the learning data of the learning board 200 in accordance with the learning steps (levels) of the user and the levels of the learning contents.

For example, as described above, when the panel 145 is a display and the user clicks a forward button (not shown) in the function button unit 150, the present learning board 200 may be replaced by the learning board 200 of the next step on the panel 145 by control of the processor 115.

Further, it is possible to store the present date in the schedule storage 125 such that scheduled learning boards 200 can be automatically displayed on the screen by control of the processor 115, in accordance with dates.

Further, it is possible to automatically display the learning board 200 of the next level (process) on the screen by means of control of the processor 115, in accordance with the learned time or the learning result, by storing information on the learned time (data and month etc.) and the learning results (points etc.) in the schedule storage 125. Further, the user can check the learned time and the learning results in voice or video.

Further, the schedule storage 125 stores time information on the learning time for the learning contents in the learning board and can inform that it is the learning time with sound (voice) or video by control of the processor 115, when it is a predetermined time. The time information may be information that is determined and stored at user's option and the time may be stored through the function button unit 150.

When video has been recorded or the user's voice (various other sounds) has been recorded through the function button unit 150, it is possible to make corresponding video or user's voice be outputted at a predetermined time. Therefore, it is possible to induce infants to listen to parents' voice and more friendly approach the learning device 100 at a predetermined time, and it is possible to allow for learning at a predetermined time against forgetfulness. When the schedule storage 125 is included in FIG. 2, obviously, the learning device 100 of FIG. 2 can perform the same functions.

Further, the contents of the scheduled learning data may be collectively displayed on the screen of the panel 145 such that the user can check the contents that he/she is supposed to learn and select learning data (or learning board 200) at his/her level through the function button unit 150.

Therefore, it is possible to select a learning contents at the user's level with more systematic learning, such that the schedule storage 125 can schedule the leaning step and the level of the learning content of the learning board 200 by control of the processor 115, by storing the identification number of the learning board 200 with the scheduling information.

For example, when the identification numbers are set to a first step, a second step, . . . and an N-th step in accordance with the levels and the present learning board 200 is for the second step, the learning board is automatically changed to the third step and corresponding learning data is outputted when the user selects the next step through the function button unit 150.

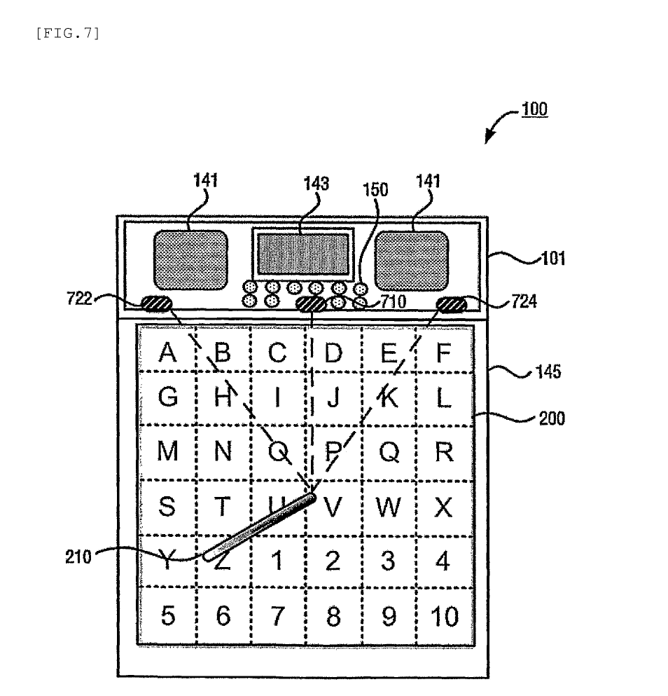

Meanwhile, FIG. 7 is a conceptual diagram illustrating the principle of a learning device according to another embodiment of the present invention.

The learning device 100 shown in FIGS. 1 and 5 calculates the position indicated by the indicator 210 and outputs learning data corresponding to the position, using the principle in which, as described above in the first position recognition method and the second position recognition method, as a signal is transmitted from the indicator 210 indicating a predetermined position on the learning board 200 to the transceiver 110, the transceiver 110 transmits a signal for recognizing the position of the indicator 210 to the indicator 210 and receives the signal reflected from the indicator 210.

On the contrary, as shown in FIG. 7, in the learning device 100 according to another embodiment of the present invention, the transceiver 110 receives a wireless signal transmitted when the indicator 210 presses a predetermined position on the learning board 200, even though the transceiver 110 does not transmit a specific signal to the indicator 210, thereby calculating the position indicated by the indicator 210.

In this configuration, the transceiver 110 according to another embodiment of the present invention is a receiving sensor and the receiving sensor includes an infrared sensor 710 and a first ultrasonic sensor 722 and a second ultrasonic sensor 724 which are disposed at predetermined distances from the main body 101 and receive ultrasonic signals.

Further, the wireless signals transmitted from the indicator 210 are an infrared signal and an ultrasonic signal, the indicator 210 includes a contact recognizer having an of/off switch, and when the switch of the contact recognizer is turned on, an infrared signal and an ultrasonic signal can be transmitted from the indicator 210 to the receiving sensor. The infrared signal and the ultrasonic signal may be transmitted only when the indicator 210 contacts with the outer surface of the learning board 200 or at a predetermined cycle after the contact.

To be more specific, as shown in FIG. 7, as the user presses a predetermined position on the learning board 200 with the indicator 210, wireless signals (infrared signal and ultrasonic signal) are transmitted from the indicator 210 toward the main body 101.

Accordingly, the infrared sensor 710 that has received the infrared signal from the indicator 210 is turned on while the first ultrasonic sensor 722 and the second ultrasonic sensor 724 receive the ultrasonic signal transmitted from the indicator 210.

In this configuration, since the infrared travels at the light speed, the infrared sensor immediately receives the corresponding signal, and the ultrasonic wave is received a little later to the first ultrasonic sensor 722 and the second ultrasonic sensor 724. The time that the ultrasonic wave is received to the first ultrasonic sensor 722 and the second ultrasonic sensor 724 is measured by this principle.

That is, the time that the infrared is received to the infrared sensor 710 is the reference time and the time taking the ultrasonic wave to be received to the first ultrasonic sensor 722 and the second ultrasonic sensor 724 from the reference time is the time taking the ultrasonic wave to reach the first ultrasonic sensor 722 and the second ultrasonic sensor 724 after being transmitted from the indicator 210.

Therefore, the processor 115 measures the position on the learning board 200 indicated by the indicator 210, using the distance between the indicator 210 and the first ultrasonic sensor 722 which has been measured on the basis of the first ultrasonic signal received to the first ultrasonic sensor 722 from the indicator 210, the distance between the indicator 210 and the second ultrasonic sensor 724 which has been measured on the basis of the second ultrasonic signal received to the second ultrasonic sensor 724 from the indicator 210, and the distance between the first ultrasonic sensor 722 and the second ultrasonic sensor 724, in which the triangulation may be used.

Further, the processor 115 checks the coordinates corresponding to the position indicated by the indicator 210 and then show the learning data corresponding to the coordinates through the output unit 140.

Although FIG. 7 shows the main body 101 and the panel 145, the learning device 100 may be implemented in the any one of the configurations shown in FIG. 1 and FIG. 5, and accordingly, it is obvious that the components of the learning device 100 may be implemented in the module shown in FIG. 2 or FIG. 6.

The learning information manager 120 may be implemented by a nonvolatile memory, such as a cash, a ROM (Read Only Memory), a PROM (Programmable ROM), an EPROM (Erasable Programmable ROM), an EEPROM (Electrically Erasable Programmable ROM) and a flash memory, or a volatile memory, such as a RAM (Random Access Memory), but is not limited thereto.

Further, the components shown in FIGS. 2 and 6 may be implemented in modules. The module implies software or FPGA (Field Programmmable Gate Array) or hardware, such as an ASIC (Application Specific Integrated Circuit), and performs predetermined functions. However, the module is not limited to the software and hardware. The module may be implemented in a storage medium that can be addressed or may be implemented to activate one or more processors. The functions provided by the components and the modules may be combined in a smaller number of components and modules, or may be divided into additional components and modules.

Although embodiments of the present invention has been described above with reference to the accompanying drawings, those skilled in the art could understand that the present invention may be implemented in other concrete ways without changing the scope or the necessary features. Therefore, it should be understood that the embodiments described above are examples and do not limit the present invention.

1. A learning device, comprising:
a main body disposed on a learning board representing learning contents; and
an indicator indicating a predetermined position on the learning board under the main body,
wherein the main body includes:
a transceiver that transmits a signal for recognizing the position to the indicator and receives a signal reflected from the indicator;
a processor that calculates the position on the learning board indicated by the indicator by communicating a signal with the indicator; and
an output unit that outputs learning data corresponding to the position calculated by the processor.

2. The learning device according to claim 1, wherein the transceiver is composed of a first transceiver and a second transceiver which are installed at predetermined distances from the main body.

3. The learning device according to claim 2, wherein the processor calculates the position on the learning board indicated by the indicator, using an angle α measured on the basis of a first signal that is transmitted from the first transceiver to the indicator and then reflected from the indicator to the second transceiver, an angle β measured on the basis of a second signal that is transmitted from the second transceiver to the indicator and then reflected from the indicator to the first transceiver, and the distance between the first transceiver and the second transceiver.

4. The learning device according to claim 2, wherein the processor calculates the position on the learning board indicated by the indicator, using a distance between the first transceiver and the indicator which is measured on the basis of a first signal that is transmitted from the first transceiver to the indicator and then reflected from the indicator to the first transceiver, a distance between the second transceiver and the indicator which is measured on the basis of a second signal that is transmitted from the second transceiver to the indicator and then reflected from the indicator to the second transceiver, and the distance between the first transceiver and the second transceiver.

5. The learning device according to claim 1, wherein the signal received to the indicator is any one of an RF signal and an ultrasonic signal.

6. The learning device according to claim 1, wherein the output unit includes at least one of a voice output unit that outputs the learning data in voice and a video output unit that outputs the learning data in video.

7. The learning device according to claim 1, wherein the indicator includes a contact recognizer having an on/off switch disposed at an end in a spring type, and the transceiver transmits the signal to the indicator when the switch of the contact recognizer is turned on.

8. The learning device according to claim 1, wherein the main body further includes:
a learning data storage that stores learning contents of the learning board in learning data type made in data; and
a schedule storage that stores at least one of time information on a learning time for the learning contents of the learning board and information on a learned time and learning results.

9. The learning device according to claim 8, wherein the main body further includes a function button unit having at least one of a button for selecting learning method of the learning contents in the learning board, a set button for setting the learning time, a sound record button for recording the voice of a user, and a video record button for recording video.

10. The learning device according to claim 9, wherein the schedule storage outputs recorded voice or recorded video on a screen at the learning time.

11. The learning device according to claim 8, wherein the main body further includes an interface that communicates data with an external device, and the interface allows data about the learning results to be analyzed by the external device by transmitting information on the learning results to the external device.

12. The learning device according to claim 1, wherein the main body further includes a scan unit that scans and images the learning contents of the learning board and creates the imaged learning contents of the learning board in the learning data.

13. A learning device comprising:
a main body disposed on a learning board representing learning contents; and
an indicator indicates a predetermined position on the learning board under the main body and transmitting wireless signals to the main body,
wherein the main body includes:
a receiving sensor that receives a wireless signal transmitted from the indicator;
a processor that calculates the position indicated by the indicator, using the wireless signal received to the receiving sensor; and
an output unit that outputs learning data corresponding to the position calculated by the processor.

14. The learning device according to claim 13, wherein the wireless signals are an infrared signal and an ultrasonic signal, and
the receiving sensor is composed of an infrared sensor that receives the infrared signal and a first ultrasonic sensor and a second ultrasonic sensor which are installed at predetermined distances from the main body and receive the ultrasonic signal.

15. The learning device according to claim 14, wherein the infrared sensor is turned on when receiving an infrared signal from the indicator such that the first ultrasonic sensor and the second ultrasonic sensor receive ultrasonic signals transmitted from the indicator.

16. The learning device according to claim 13, wherein the processor calculates the position on the learning board indicated by the indicator, using a distance between the indicator and the first ultrasonic sensor which is measured on the basis of a first ultrasonic signal transmitted from the indicator to the first ultrasonic sensor, a distance between the indicator and the second ultrasonic sensor which is measured on the basis of a second ultrasonic signal transmitted from the indicator to the second ultrasonic sensor, and the distance between the first ultrasonic sensor and the second ultrasonic sensor.

17. The learning device according to claim 16, wherein the indicator includes a contact recognizer having an on/off switch disposed at an end in a spring type and transmits the infrared signal and the ultrasonic signal to the receiving sensor, when the switch of the contact recognizer is turned on.

18. The learning device according to claim 2, wherein the main body further includes a scan unit that scans and images the learning contents of the learning board and creates the imaged learning contents of the learning board in the learning data.

19. The learning device according to claim 3, wherein the main body further includes a scan unit that scans and images the learning contents of the learning board and creates the imaged learning contents of the learning board in the learning data.

20. The learning device according to claim 4, wherein the main body further includes a scan unit that scans and images the learning contents of the learning board and creates the imaged learning contents of the learning board in the learning data.

21. The learning device according to claim 5, wherein the main body further includes a scan unit that scans and images the learning contents of the learning board and creates the imaged learning contents of the learning board in the learning data.

22. The learning device according to claim 6, wherein the main body further includes a scan unit that scans and images the learning contents of the learning board and creates the imaged learning contents of the learning board in the learning data.

23. The learning device according to claim 7, wherein the main body further includes a scan unit that scans and images the learning contents of the learning board and creates the imaged learning contents of the learning board in the learning data.

24. The learning device according to claim 8, wherein the main body further includes a scan unit that scans and images the learning contents of the learning board and creates the imaged learning contents of the learning board in the learning data.

25. The learning device according to claim 9, wherein the main body further includes a scan unit that scans and images the learning contents of the learning board and creates the imaged learning contents of the learning board in the learning data.

26. The learning device according to claim 10, wherein the main body further includes a scan unit that scans and images the learning contents of the learning board and creates the imaged learning contents of the learning board in the learning data.

27. The learning device according to claim 11, wherein the main body further includes a scan unit that scans and images the learning contents of the learning board and creates the imaged learning contents of the learning board in the learning data.
